(19) United States
(12) Patent Application Publication
(10) Pub. No.: US 2025/0245620 A1
(43) Pub. Date: Jul. 31, 2025

(54) SYSTEMS AND METHODS FOR INVENTORY PLACEMENT AND DEMAND ALLOCATION

(71) Applicant: Walmart Apollo, LLC, Bentonville, AR (US)

(72) Inventors: Kenneth David Kuhn, Pasadena, CA (US); Arash Sangari, Frisco, TX (US); Hoda Parvin, Seattle, WA (US); Shaun Robert Rorrison, Bentonville, AR (US); Jashandeep Singh, Centerton, AR (US); Jason Huchung Pang, San Francisco, CA (US); Anantha Ravi Kiran Lanka Subrahmanya, San Jose, CA (US); Maryam Bahojb Imani, Sunnyvale, CA (US); John Michael Jackson, Bentonville, AR (US)

(21) Appl. No.: 18/428,459

(22) Filed: Jan. 31, 2024

(51) Int. Cl. G06Q 10/087; G06Q 30/0202

(52) U.S. Cl. CPC G06Q 10/087; G06Q 30/0202

(57) ABSTRACT

Systems and methods for inventory placement and demand allocation of items in a retail fulfillment network are disclosed. In some embodiments, a disclosed method includes: receiving, from a computing device, a recommendation request regarding a plurality of nodes in a retail fulfillment network; obtaining feature data based on the recommendation request; computing, using at least one machine learning model, recommendation data based on the feature data, wherein the recommendation data indicates at least one recommendation regarding inventory placement and demand allocation among the nodes in the retail fulfillment network; and transmitting, in response to the recommendation request, the recommendation data to the computing device.

### TECHNICAL FIELD

This application relates generally to inventory placement and, more particularly, to systems and methods for inventory placement and demand allocation of items in a retail fulfillment network.

### BACKGROUND

A retail fulfillment network is a network formed by various nodes, e.g. stores, warehouses, fulfillment centers, etc. Inventory placement is a fundamental supply chain design decision for a retailer, to determine how to place an inventory of items across different nodes in the retail fulfillment network. Existing solutions for inventory placement consider the space available at nodes as a one-dimensional constraint, without considering other factors or problems like demand allocation.

### SUMMARY

The embodiments described herein are directed to systems and methods for inventory placement and demand allocation of items in a retail fulfillment network.

In various embodiments, a system including a non-transitory memory configured to store instructions thereon and at least one processor is disclosed. The at least one processor is operatively coupled to the non-transitory memory and configured to read the instructions to: receive, from a computing device, a recommendation request regarding a plurality of nodes in a retail fulfillment network; obtain feature data based on the recommendation request; compute, using at least one machine learning model, recommendation data based on the feature data, wherein the recommendation data indicates at least one recommendation regarding inventory placement and demand allocation among the nodes in the retail fulfillment network; and transmit, in response to the recommendation request, the recommendation data to the computing device.

In various embodiments, a computer-implemented method is disclosed. The computer-implemented method includes: receiving, from a computing device, a recommendation request regarding a plurality of nodes in a retail fulfillment network; obtaining feature data based on the recommendation request; computing, using at least one machine learning model, recommendation data based on the feature data, wherein the recommendation data indicates at least one recommendation regarding inventory placement and demand allocation among the nodes in the retail fulfillment network; and transmitting, in response to the recommendation request, the recommendation data to the computing device.

In various embodiments, a non-transitory computer readable medium having instructions stored thereon is disclosed. The instructions, when executed by at least one processor, cause at least one device to perform operations including: receiving, from a computing device, a recommendation request regarding a plurality of nodes in a retail fulfillment network; obtaining feature data based on the recommendation request; computing, using at least one machine learning model, recommendation data based on the feature data, wherein the recommendation data indicates at least one recommendation regarding inventory placement and demand allocation among the nodes in the retail fulfillment network; and transmitting, in response to the recommendation request, the recommendation data to the computing device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for inventory placement and demand allocation of items in a retail fulfillment network, in accordance with some embodiments of the present teaching;

FIG. 2 is a block diagram of an inventory placement and demand allocation device, in accordance with some embodiments of the present teaching;

FIG. 3 is a block diagram illustrating various portions of a system for recommending inventory placement and demand allocation of items in a retail fulfillment network, in accordance with some embodiments of the present teaching;

FIG. 4 illustrates an exemplary problem of inventory placement, in accordance with some embodiments of the present teaching;

FIG. 5 illustrates an exemplary diagram of a system for inventory placement and demand allocation, in accordance with some embodiments of the present teaching;

FIG. 6 illustrates an exemplary process for recommending inventory placement and demand allocation data, in accordance with some embodiments of the present teaching;

FIG. 7 illustrates an exemplary process for computing and evaluating delivery speed elasticity, in accordance with some embodiments of the present teaching;

FIG. 8 illustrates an exemplary item category hierarchy, in accordance with some embodiments of the present teaching;

FIG. 9 illustrates a process for generating item bundles, in accordance with some embodiments of the present teaching;

FIG. 10 is a flowchart illustrating an exemplary method for recommending inventory placement and demand allocation, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

An inventory placement is a decision regarding where to place products within a retail fulfillment network including stores and warehouses. A demand allocation is a decision regarding what fraction of each geographic region's demand for each product will be served via each node in the retail fulfillment network within a given time period. Retailers must make these decisions on a recurring basis. The relatively large numbers of products for sale, nodes in the network, and operational requirements make these problems particularly challenging for large retailers.

One objective of the present teaching is to provide systems and methods for recommending inventory placement and demand allocation at the same time for items in a retail fulfillment network. In some embodiments, a system including an inventory placement and demand allocation engine determines and provides these recommendations based on machine learning and mathematical optimization. The system can assist a user in deciding where and when to position an inventory in a retail fulfillment network and how to use that inventory to satisfy demand. The system can simultaneously make both inventory placement and demand allocation decisions.

In some embodiments, the disclosed system can determine the most efficient locations for storing and shipping products while considering factors such as geographic demand patterns, outbound shipping cost and storage capacity of the fulfillment nodes. The system utilizes a time phased model that considers non-stationary demand and manages trade-offs of customer experience and satisfaction, shipping and other fulfillment costs, capacity consumption, and retailer revenue. In some embodiments, the system includes delivery speed elasticity, item bundling, fulfillment channel preference, demand update, and placement optimization modules.

In some embodiments, the system meets various operational constraints, the majority of which refer to capacities at nodes. For example, the system separately considers the volumes of space available at each node in a fulfillment network to store aerosol and oil baffle hazardous materials.

In some embodiments, the system also accounts for a relationship between demand and delivery speed. Accounting for delivery speed elasticity and all of the operational constraints within a placement optimization problem with millions of products and thousands of nodes can be technically challenging. In some embodiments, item bundling and clustering methods are utilized to reduce computation complexity and provide efficient and effective recommendations.

Furthermore, in the following, various embodiments are described with respect to systems and methods for inventory placement and demand allocation of items in a retail fulfillment network are disclosed. In some embodiments, a disclosed method includes: receiving, from a computing device, a recommendation request regarding a plurality of nodes in a retail fulfillment network; obtaining feature data based on the recommendation request; computing, using at least one machine learning model, recommendation data based on the feature data, wherein the recommendation data indicates at least one recommendation regarding inventory placement and demand allocation among the nodes in the retail fulfillment network; and transmitting, in response to the recommendation request, the recommendation data to the computing device.

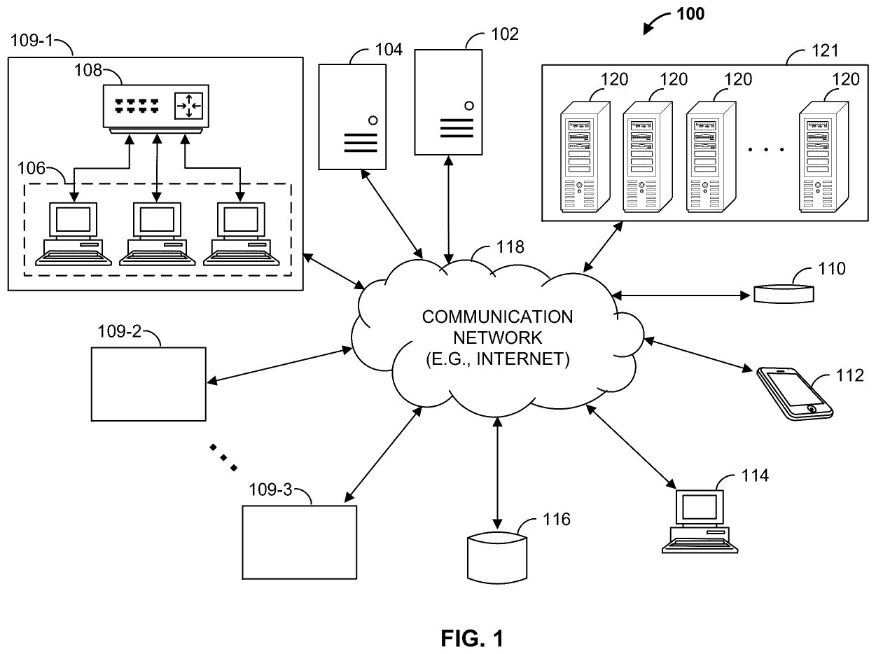

Turning to the drawings, FIG. 1 is a network environment 100 configured for recommending inventory placement and demand allocation of items, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an inventory placement and demand allocation device 102, a server 104 (e.g., a web server or an application server), a cloud-based engine 121 including one or more processing devices 120, workstation(s) 106, a database 116, and one or more user computing devices 110, 112, 114 operatively coupled over the network 118. The inventory placement and demand allocation device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the inventory placement and demand allocation device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the inventory placement and demand allocation device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the inventory placement and demand allocation device 102, the processing devices 120, and/or the server 104 are operated by a retailer, and the multiple user computing devices 110, 112, 114 are operated by customers, associates and/or managers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109.

The workstation(s) 106 can communicate with the inventory placement and demand allocation device 102 over the communication network 118. The workstation(s) 106 may send data to, and receive data from, the inventory placement and demand allocation device 102. For example, the workstation(s) 106 may transmit data identifying items purchased by a customer at the fulfillment nodes 109 to the inventory placement and demand allocation device 102. The workstation(s) 106 may also transmit other data related to the fulfillment nodes 109 to the inventory placement and demand allocation device 102.

Although FIG. 1 illustrates three user computing devices 110, 112, 114, the network environment 100 can include any number of user computing devices 110, 112, 114. Similarly, the network environment 100 can include any number of the inventory placement and demand allocation devices 102, the processing devices 120, the workstations 106, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, each of the multiple user computing devices 110, 112, 114 may be operable to view, access, and interact with a website, such as a retailer's website, hosted by the server 104. The server 104 may capture user session data related to a customer's activity (e.g., interactions) on the website.

In some examples, a customer may operate one of the user computing devices 110, 112, 114 to initiate a web browser that is directed to the website hosted by the server 104. The customer may, via the web browser, view item advertisements for items displayed on the website, and may click on item advertisements, for example. The website may capture these activities as user session data, and transmit the user session data to the inventory placement and demand allocation device 102 over the communication network 118. The website may also allow the operator to add one or more of the items to an online shopping cart, and allow the customer to perform a “checkout” of the shopping cart to purchase the items. In some examples, the server 104 transmits purchase data identifying items the customer has purchased from the website to the inventory placement and demand allocation device 102.

In some examples, a customer may go to a store, e.g. the fulfillment node 109-1 for purchasing items. The customer may use some payment method, e.g. a credit card or a payment app, at the fulfillment node 109-1 to purchase one or more items. The workstation(s) 106 in the fulfillment node 109-1 may capture these activities as in-store purchase data, and transmit the in-store purchase data to the inventory placement and demand allocation device 102 over the communication network 118, together with other node related data.

In some examples, the inventory placement and demand allocation device 102 may receive a recommendation request regarding inventory placement and demand allocation of items being sold by a retailer from the server 104. The recommendation request may be sent standalone or together with data associated with a retail fulfillment network (or called supply chain network or distribution network) of the retailer, to seek recommendations on how to place different items at different nodes in the retail fulfillment network, and how to allocate percentage of customer demand of a product among the nodes holding the product. In some examples, the recommendation request may also be sent by one of the fulfillment nodes 109 to seek recommendations on inventory placement and demand allocation of items in the fulfillment node. In response, the inventory placement and demand allocation device 102 generates recommendation data indicating recommendations regarding inventory placement and demand allocation among the nodes in the retail fulfillment network.

In some examples, the inventory placement and demand allocation device 102 may execute one or more models (e.g., programs or algorithms), such as a machine learning model, deep learning model, statistical model, etc., to generate recommendation data for inventory placement and demand allocation. The inventory placement and demand allocation device 102 may generate and transmit the recommendation data for inventory placement and demand allocation to the server 104 (or the fulfillment nodes 109) over the communication network 118, and the server 104 (or the fulfillment nodes 109) may determine how to place and allocate items accordingly.

In some embodiments, the inventory placement and demand allocation device 102 is further operable to communicate with the database 116 over the communication network 118. For example, the inventory placement and demand allocation device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the inventory placement and demand allocation device 102, in some examples, the database 116 can be a local storage device, such as a hard drive, a non-volatile memory, or a USB stick. The inventory placement and demand allocation device 102 may store online purchase data received from the server 104 in the database 116. The inventory placement and demand allocation device 102 may receive in-store purchase data and node related data from different fulfillment nodes 109 and store them in the database 116. The inventory placement and demand allocation device 102 may also receive from the server 104 user session data identifying events associated with browsing sessions, and may store the user session data in the database 116. The inventory placement and demand allocation device 102 may also compute recommendation data in response to an recommendation request received from the server 104 (or the fulfillment nodes 109), and may store the recommendation data in the database 116.

In some examples, the inventory placement and demand allocation device 102 generates and/or updates different models for recommending inventory placement and demand allocation. The models, when executed by the inventory placement and demand allocation device 102, allow the inventory placement and demand allocation device 102 to compute data related to inventory placement and demand allocation, and generate and provide recommendations based on the computed data.

In some examples, the inventory placement and demand allocation device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the inventory placement and demand allocation device 102 may generate recommendation data.

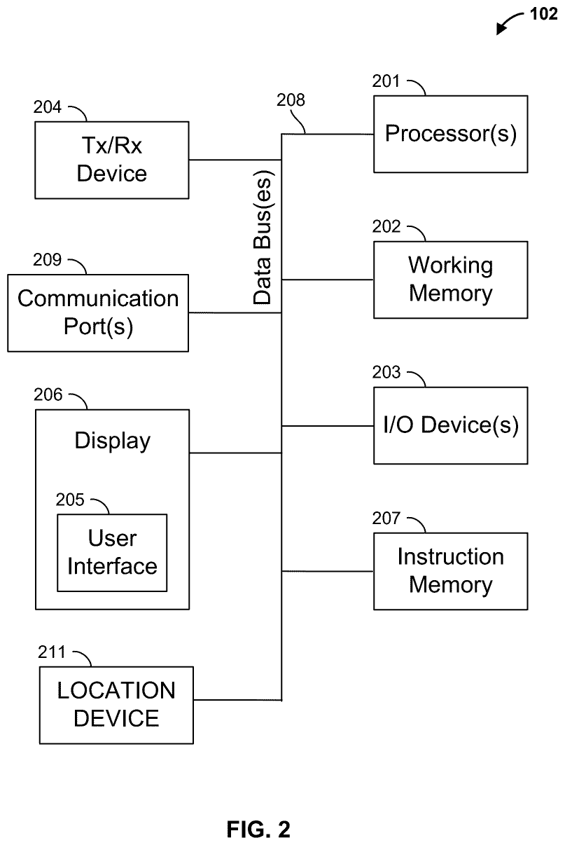

FIG. 2 illustrates a block diagram of an inventory placement and demand allocation device, e.g. the inventory placement and demand allocation device 102 of FIG. 1, in accordance with some embodiments of the present teaching. In some embodiments, each of the inventory placement and demand allocation device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the inventory placement and demand allocation device 102 can be combined, omitted, and/or replicated. In addition, it will be appreciated that additional elements other than those illustrated in FIG. 2 can be added to the inventory placement and demand allocation device 102.

As shown in FIG. 2, the inventory placement and demand allocation device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the inventory placement and demand allocation device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the inventory placement and demand allocation device 102 can include a single memory unit configured to operate as both instruction memory and working memory. Further, although embodiments are discussed herein including non-volatile memory, it will be appreciated that the inventory placement and demand allocation device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the inventory placement and demand allocation device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the inventory placement and demand allocation device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the inventory placement and demand allocation device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the inventory placement and demand allocation device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the inventory placement and demand allocation device 102 may determine a local geographical area (e.g., town, city, state, etc.) of its position.

In some embodiments, the inventory placement and demand allocation device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

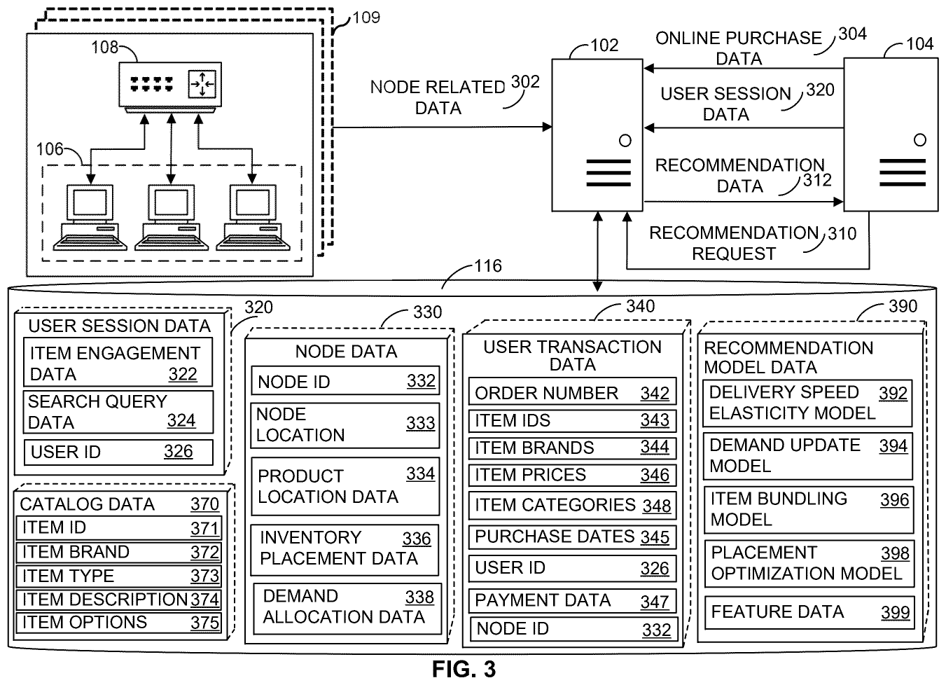

FIG. 3 is a block diagram illustrating various portions of a system for recommending inventory placement and demand allocation of items, e.g. the system shown in the network environment 100 of FIG. 1, in accordance with some embodiments of the present teaching. As indicated in FIG. 3, the inventory placement and demand allocation device 102 may receive user session data 320 from the server 104, and store the user session data 320 in the database 116. The user session data 320 may identify, for each user (e.g., customer), data related to that user's browsing session, such as when browsing a retailer's webpage hosted by the server 104.

In some examples, the user session data 320 may include item engagement data 322, search query data 324, and user ID 326 (e.g., a customer ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items added-to-cart identifying items added to the user's online shopping cart, advertisements viewed identifying advertisements the user viewed during the browsing session, and advertisements clicked identifying advertisements the user clicked on. The search query data 324 may identify one or more searches conducted by a user during a browsing session (e.g., a current browsing session). The inventory placement and demand allocation device 102 may also receive online purchase data 304 from the server 104, which identifies and characterizes one or more online purchases, such as purchases made by the user and other users via a retailer's website hosted by the server 104. The inventory placement and demand allocation device 102 may also receive node related data 302 from the fulfillment nodes 109, which identifies and characterizes one or more in-store purchases, product location data, inventory placement data, and demand allocation data related to each of the fulfillment nodes 109. In some embodiments, the node related data 302 may also indicate other information about the fulfillment nodes 109.

The inventory placement and demand allocation device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding online orders, and node ID 332 for the corresponding in-store purchase, or for the pickup store or shipping-from store associated with the corresponding online purchase.

In some embodiments, the database 116 may further store node data 330, which may identify feature data related to the fulfillment nodes 109. In some embodiments, the fulfillment nodes 109 are in a same retail fulfillment network of a retailer. Each of the fulfillment nodes 109 comprises at least one of: a store, a warehouse, a fulfillment center, or a distribution center of the retailer. The node data 330 may include, for each fulfillment node, one or more of: a node ID 332 of the fulfillment node, a node location 333 of the fulfillment node, product location data 334 indicating which product is located at which location in the fulfillment node, inventory placement data 336 identifying and charactering what inventory of products should be placed in the fulfillment node, and demand allocation data 338 identifying and charactering what fraction of a demand for each product will be served via the fulfillment node within a given time period.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store recommendation model data 390 identifying and characterizing one or more models and related data for recommending inventory placement and demand allocation. For example, the recommendation model data 390 may include: a delivery speed elasticity model 392, a demand update model 394, an item bundling model 396, a placement optimization model 398, and feature data 399.

The delivery speed elasticity model 392 may be used to compute a delivery speed elasticity, e.g. based on historical data, shipping options, price data, etc. In some embodiments, the delivery speed elasticity is computed for each item. In some embodiments, the delivery speed elasticity is computed for each item category or each item sub-category. For example, for an item lacking historical data or is entirely new, the delivery speed elasticity model 392 may utilize the item's categorical hierarchy, to estimate a delivery speed elasticity for an entire category or sub-category containing the item. The computed delivery speed elasticity will then be used to generate possible demand lift as a function of faster shipping.

The demand update model 394 may be used to compute or predict an update of demands of items. In some embodiments, the demand update is computed based on the delivery speed elasticity and some fulfillment channel preferences. For example, based on an extent of impact of faster shipping on more customer demand, the system can recommend an ideal shipping speed for each item, each item category or each item sub-category, considering feasible shipping options, shipping cost and demand life prediction.

The item bundling model 396 may be used to cluster items into bundles. In some embodiments, the item bundling model 396 includes a machine learning model configured to predict the demand of an item at a particular geo-location. In some embodiments, the item bundling model 396 also includes an affinity model configured to determine an affinity score for each pair of two items, where the affinity score captures the measure of how much more likely the two items are to be purchased together than if they were purchased independently. In some embodiments, the items are clustered into bundles based on the geo-location based demand, the affinity scores, and the delivery speed elasticities.

The placement optimization model 398 may be used to determine an inventory placement decision for a retail fulfillment network. In some embodiments, the placement optimization model 398 is utilized to maximize an objective function that includes expected revenue minus fulfillment costs. The fulfillment costs may include product shipment and inventory holding costs as well as penalty costs for any recommendations that require removing products from fulfillment nodes or adding products to fulfillment nodes. In some embodiments, the objective function is maximized by tuning decision variables, given various constraints. The decision variables and constraints are related to data and features of the nodes in the retail fulfillment network, and/or transaction data associated with the retail fulfillment network.

The feature data 399 may include data and features related to the nodes in the retail fulfillment network, and/or transactions in the retail fulfillment network. In some examples, the feature data 399 may include, but not limited to, data related to: at least one fixed rule each specifying a certain product must be placed in one or more certain nodes; an item-location eligibility indicating which products are eligible for placement in which nodes; an item affinity, which includes pair-wise scores each indicating how likely a pair of two products will be purchased together; customer experience scores, which includes data on uplift in customer satisfaction when certain products are available to be delivered in a certain timeframe; a current inventory indicating quantities of each product currently stored in each node; item prices indicating prices of items and a revenue a retailer receives when selling each product; picking costs indicating costs of taking each product out of inventory at each node; shipment costs indicating costs of shipping one unit of any product from any node to any given customer location; a geo-demand indicating a baseline demand for each product, which is broken down by geographic area; a promise definition indicating a speed with which the retailer is capable of delivering a product from a given node to a customer in a geographic area; target days of supply indicating an amount of product which must be carried in a node in order to support retailer deliveries from the node to avoid out of stock; node attributes indicating attributes on each node; a delivery speed elasticity; and/or clusters of items that need to be placed together to maximize revenue and minimize cost.

In some examples, the inventory placement and demand allocation device 102 receives a recommendation request 310 from the server 104. The recommendation request 310 may be associated with a retail fulfillment network of a retailer, e.g. the retailer associated with the inventory placement and demand allocation device 102 and/or the server 104. In some examples, the recommendation request 310 is to seek recommendations on inventory placement and demand allocation in the retail fulfillment network. In some embodiments, the inventory placement and demand allocation device 102 may obtain the feature data from the server 104 and/or the database 116, based on the recommendation request 310. Based on the feature data, the inventory placement and demand allocation device 102 may compute, using at least one machine learning model, recommendation data 312 indicating at least one recommendation regarding inventory placement and demand allocation among the nodes in the retail fulfillment network. The at least one machine learning model may include any model in the recommendation model data 390. In response to the recommendation request 310, the inventory placement and demand allocation device 102 transmits the recommendation data 312 to the server 104. In some examples, the inventory placement and demand allocation device 102 receives a recommendation request from one of the fulfillment nodes 109, then generates and transmits recommendation data to the fulfillment node. In some embodiments, the inventory placement and demand allocation device 102 may assign one or more of the above described operations to a different processing unit or virtual machine hosted by one or more processing devices 120.

In some embodiments, the disclosed system allows users with a computing device to generate and inspect a set of recommendations. The recommendations can suggest which products to be placed in inventory in which stores, warehouses, or other nodes of a fulfillment network for an omnichannel retailer. In some embodiments, the recommendations also suggest what fraction of demand for any given product in any given area to satisfy via any given node and fulfillment channel. In some embodiments, the recommendations also include reason codes explaining why certain decisions have been made. For example, the system may reveal that the retailer should satisfy 20 percent of the demand for shaving cream in San Antonio, Texas via shipments directly from a warehouse in Tulsa, Oklahoma. In another example, the recommendations may suggest that the retailer should not place shaving cream in a warehouse in Mobile, Alabama, because that warehouse is already full.

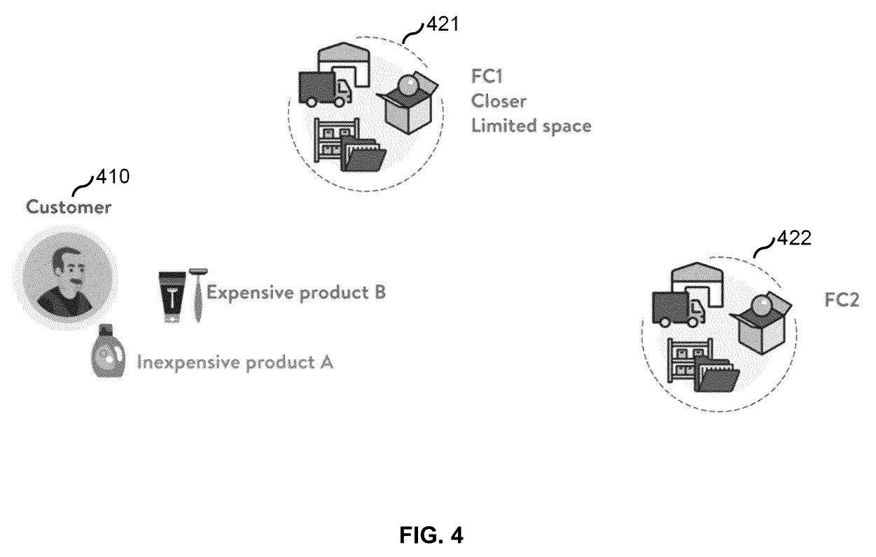

FIG. 4 illustrates an exemplary problem of inventory placement, in accordance with some embodiments of the present teaching. As shown in FIG. 4, a customer 410, representing many other potential customers, is demanding an inexpensive product A and an expensive product B. In this example, a fulfillment center FC1 421 is close to the customer 410 but may not have enough space to hold both products that the customer demands. As such, one inventory recommendation in this example may be to place product A and/or product B (or a portion of the entire inventory) in a fulfillment center FC2 422, although the fulfillment center FC2 422 is far from the customer 410. In general, an ideal assignment of products to FC1 421 and FC2 422 will depend on the prerogatives and operational constraints of the retailer.

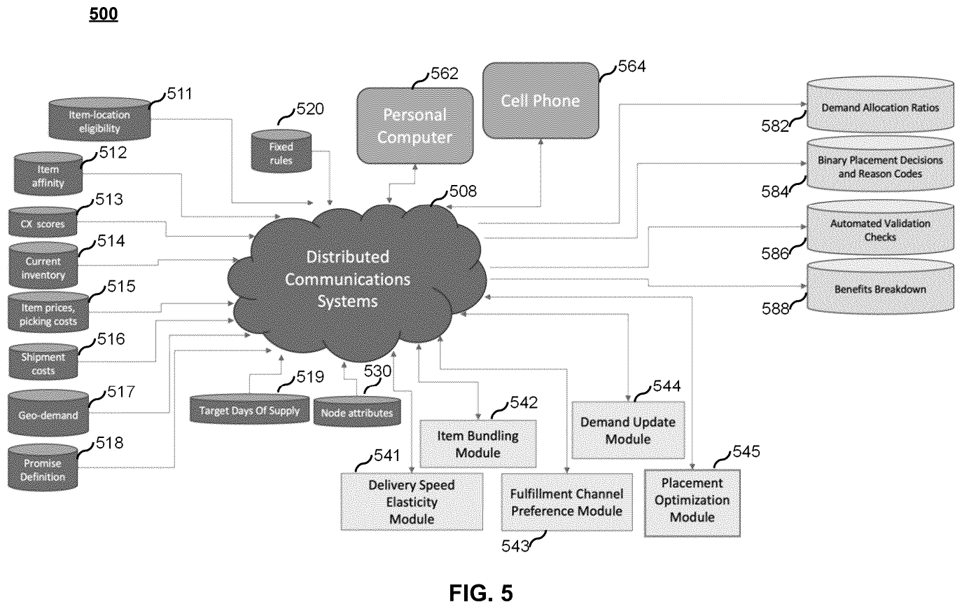

FIG. 5 illustrates an exemplary diagram of a system 500 for inventory placement and demand allocation, in accordance with some embodiments of the present teaching. In some embodiments, the system 500 can be implemented by the inventory placement and demand allocation device 102 and/or the server 104 in FIG. 1 and/or FIG. 3.

In the example shown in FIG. 5, the system 500 is made up of several distributed communications systems 508. These systems 508 can load feature data 511˜519, 520, 530 from several relevant data tables or databases. In some embodiments, these systems 508 pass the loaded data to several modules 541˜545. Each of the modules 541˜545 can subsequently pass back new data that power other modules and the recommendations regarding inventory placement and demand allocation. The recommendations and other useful module output data may be stored in databases 582˜588, and/or provided to users, e.g. via user interfaces on a personal computer 562 and/or a cell phone 564.

In FIG. 5, the feature data 511˜519, 520, 530 are the inputs to the systems 508, while the elements in databases 582˜588 are the outputs. In some embodiments, the inputs include but not limited to data related to: an item-location eligibility 511, an item affinity 512, customer experience (CX) scores 513, current inventory 514, item prices and picking costs 515, shipment costs 516, geo-demand 517, promise definition 518, target days of supply 519, fixed rules 520, and node attributes 530. In some embodiments, one or more of the feature data 511˜519, 520, 530 is stored in a standalone database. In some embodiments, one or more of the feature data 511˜519, 520, 530 is stored in the database 116.

In some examples, the item-location eligibility 511 indicates which products are eligible for placement in which nodes. The data of item affinity 512 may include pair-wise scores indicating how likely it is that any two products will be purchased together. The CX scores 513 may indicate an uplift in customer satisfaction when certain products can be delivered in a certain timeframe. The current inventory 514 can indicate quantities of each product currently stored in each node of the retail fulfillment network. The item prices and picking costs 515 can indicate the revenue the retailer receives when selling each product and the cost of taking each product out of inventory at each node, respectively. The shipment costs 516 indicate the costs of shipping one unit of any product from any node to any given customer location. The geo-demand 517 indicates a baseline demand for each product, broken down by geographic areas. The promise definition 518 indicates the speed with which the retailer can deliver a product from a given node to a customer in a geographic area. The target days of supply 519 indicates an amount of product which must be carried in a node in order to support retailer deliveries from the node, accounting for safety stock to avoid out of stock of the product at the node. The fixed rules 520 are previously set rules specifying that certain products must be placed in certain nodes. The node attributes 530 are attributes on each node, including e.g. the volume of space available for storing product, the maximum inbound and outbound throughput of the node, and the maximum dimensions of products which can be stored in the node.

The delivery speed elasticity module 541 can take historical data, shipping options and item prices from the feature data, and generate possible demand lift as a function of faster shipping. The item bundling module 542 in this example generates clusters of items that need to be placed together to maximize revenue and minimize cost. The fulfillment channel preference module 543 in this example determines a preference to one or more fulfillment channel over other fulfillment channels for any given item. The demand update module 544 in this example determines an updated demand for any given item. The placement optimization module 545 in this example generates an optimized inventory placement for any given item in the retail fulfillment network.

In some embodiments, the outputs of the system 500 include but not limited to data related to: demand allocation ratios 582, binary placement decisions and reason codes 584, automated validation checks 586, and benefits breakdown 588. In some embodiments, one or more of the output data 582˜588 is stored in a standalone database. In some embodiments, one or more of the output data 582˜588 is stored in the database 116.

In some examples, the demand allocation ratios 582 indicate what fraction of demand for each product in each geographic area will be served via each node, e.g. within each week. For example, if it is determined that a node should serve 25% of the demand of an item for a given geographic area, the node may need to ship out some of the item inventory to other nodes or receive some of the item inventory from other nodes, to meet the 25% requirement. The binary placement decisions and reason codes 584 indicate whether each product will or will not be stored in each node each week and short descriptions of the reasons behind the decision, respectively. The automated validation checks 586 include a list of checks performed during output generation and information on whether the checks were successful. For example, one validation check is that a total sum of demand allocation ratios of all nodes holding an item for a geographic area must be equal to 100%. The benefits breakdown 588 indicates detailed data of the individual costs and benefits considered during output generation. For example, when new items are introduced, the benefits breakdown 588 can indicate the system thinks whether it is financially beneficial to place them or where to place them in the retail fulfillment network.

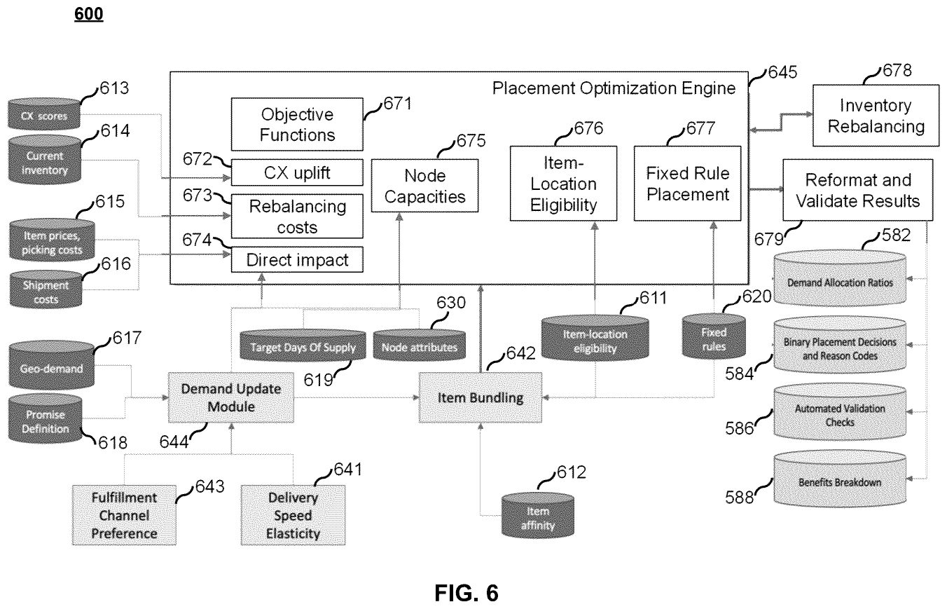

FIG. 6 illustrates an exemplary process 600 performed by a system for recommending inventory placement and demand allocation data, e.g. the system 500 in FIG. 5, in accordance with some embodiments of the present teaching. In some embodiments, the placement optimization engine 645 in FIG. 6 is a detailed version of the placement optimization module 545 in FIG. 5. The placement optimization engine 645 in this example generates the recommendations for inventory placement and demand allocation, based on various objective functions 671 being optimized and various constraints being met. In some embodiments, each of these functions 671 is parameterized using pre-defined datasets. FIG. 6 shows a detailed process 600 of how data is used by the placement optimization engine 645 and other modules within the system 500.

For example, an item-location eligibility dataset 611 includes data indicating which items are eligible to be placed in which nodes. This data is used to set an item-location eligibility constraint 676 within the placement optimization engine 645, to be met when performing inventory placement optimization by the placement optimization engine 645. For example, the item-location eligibility constraint 676 may specify that a node with high automation cannot accept long items because the robots at that node cannot handle those long items, or specify that hazmat items cannot be stored or handled in some nodes.

In some examples, an item affinity dataset 612 includes pair-wise scores each indicating how likely a pair of two products will be purchased together. These item affinity data may be used to generate item bundles by an item bundling module 642.

In some examples, a CX scores dataset 613 includes customer experience scores. The customer experience scores may be used by the placement optimization engine 645 to compute CX uplift 672 in customer satisfaction e.g. when certain products are available to be delivered in a certain timeframe. In some embodiments, the outputs of the placement optimization engine 645 will directly impact the CX scores in the CX scores dataset 613. As such, data in the CX scores dataset 613 can be treated as a feedback to the placement optimization engine 645.

In some examples, a current inventory dataset 614 includes quantities of each product currently stored in each node. The data in the current inventory dataset 614 may be used by the placement optimization engine 645 to compute rebalancing costs 673 indicating costs of shipping items from one node to another in the retail fulfillment network.

In some examples, a dataset 615 includes: item prices indicating prices of items and a revenue a retailer receives when selling each product, and picking costs indicating costs of taking each product out of inventory at each node. A shipment costs dataset 616 includes shipment costs indicating costs of shipping one unit of any product from any node to any given customer location. The data in the datasets 615, 616 may be used by the placement optimization engine 645 to compute a direct impact 674 on inventory placement, e.g. cost of actually shipping goods from a fulfillment center to a customer.

In some examples, a geo-demand dataset 617 includes a baseline demand for each product, which is broken down by geographic area. A promise definition dataset 618 in this example includes promise data indicating a speed with which the retailer is capable of or promises for delivering a product from a given node to a customer in a geographic area. The data in the geo-demand dataset 617 and the promise definition dataset 618 may be used by a demand update module 644 to compute an updated demand for any given item.

In some examples, a target days of supply dataset 619 includes data indicating an amount of product which must be carried in a node in order to support retailer deliveries from the node to avoid out of stock. The data in the target days of supply dataset 619 may be used by the placement optimization engine 645 to compute node capacities 675 for each node in the retail fulfillment network.

In some examples, a fixed rules dataset 620 includes rules specifying a certain product must be placed in one or more certain nodes, e.g. based on business requirements. These rules may be used to set a fixed rule placement constraint 677 within the placement optimization engine 645, to be met when performing inventory placement optimization by the placement optimization engine 645. In some examples, a fixed rule may specify that some product must be stored at nodes having a serial scanning capability.

In some examples, a node attributes dataset 630 includes attributes on each node. In some embodiments, these attributes may be used by the placement optimization engine 645 to compute the direct impact 674 on inventory placement, and/or compute the node capacities 675 for each node in the retail fulfillment network.

As shown in FIG. 6, a delivery speed elasticity module 641 is configured to compute a delivery speed elasticity for any given item and send the delivery speed elasticity to the demand update module 644. In addition, the system includes a fulfillment channel preference module 643 configured to compute a fulfillment channel preference for any given item and send the fulfillment channel preference to the demand update module 644.

In the example shown in FIG. 6, the demand update module 644 is configured to compute an updated demand for each given item, based on the delivery speed elasticity, the fulfillment channel preference, and data from the datasets 617, 618. In some embodiments, the updated demand may be sent to the placement optimization engine 645 to compute the direct impact 674 on inventory placement, and/or compute the node capacities 675 for each node in the retail fulfillment network.

In some embodiments, the updated demand may be sent to an item bundling module 642 for clustering items into bundles. The item bundling module 642 in this example is configured to generate item bundles based on: the updated demand, and data from datasets 611, 612, 620. In some embodiments, each item bundle indicates a cluster of items that need to be placed together during inventory placement, to maximize revenue and minimize cost. In some embodiments, the placement optimization engine 645 performs inventory placement optimization at the bundle level, especially for items lacking historical data.

The placement optimization engine 645 in this example optimizes the objective functions 671, based on parameters including the CX uplift 672, the rebalancing costs 673, the direct impact 674, and subject to constraints including the node capacities 675, the item-location eligibility constraint 676, the fixed rule placement constraint 677. The placement optimization engine 645 generates recommendations regarding inventory placement and demand allocation among the nodes in the retail fulfillment network, by optimizing the objective functions 671 while meeting the constraints.

In some embodiments, the placement optimization engine 645 sends its recommendations to an inventory rebalancing module 678, which can perform a similar optimization. The inventory rebalancing module 678 in this example evaluates and forecasts inventory positions based on the recommendations of the placement optimization engine 645, and identifies optimal policies for rebalancing inventory, moving items from one node to another within the retailer's fulfillment network. In some embodiments, the inventory rebalancing module 678 sends a feedback of the optimal policies to the placement optimization engine 645 for confirming or updating the recommendation results.

In some embodiments, the recommendation results generated by the placement optimization engine 645 are reformatted and validated at operation 679, and then stored in databases 582˜588. As discussed above, data in each of the databases 582˜588 may also be provided to users for making decisions regarding inventory placement and demand allocation among the nodes in the retail fulfillment network.

In some embodiments, the placement optimization engine 645 formulates the relevant inventory placement problem using a mathematical programming approach. The approach maximizes an objective function that includes expected revenue minus fulfillment costs, including product shipment and inventory holding costs as well as penalty costs for any recommendations that require removing products from nodes or adding products to nodes. The approach is space-aware, meeting constraints on the cubic volume of space available overall at nodes, on the volume of space available for storing various types of hazardous materials at nodes, and on the number of products that can be stored at nodes. The approach is also throughput-aware, meeting constraints on the maximum number of items that can be sent to and from nodes during a week. The approach also considers various other operational rules, for example rules that the retailer has with a vendor which prohibit or require storing certain products in certain stores.

In some embodiments, different data sets for a placement optimization mathematical programming formulation are defined as follows. G represents a set of Geo-IDs, which indicate geographic areas for which forecast demand data are computed. N represents a set of nodes, which indicate warehouses, fulfillment centers, distribution centers and stores in the retail fulfillment network. Q represents a set of bundles, which indicate groups of items which are similar for placement purposes. S represents a set of dimensions of cube capacity, including e.g. total cubic volume, cube volume for aerosol hazmat items, and cube volume for oil baffle hazmat items. T represents a set of dimensions of throughput capacity, e.g. inbound and outbound throughput capacities. SN represents a set of super nodes, where all items will be placed in super nodes. IL represents a set of node-bundle pairs where a bundle cannot be placed in the paired node due to item-location eligibility rules.

In some embodiments, different model parameters for the placement optimization mathematical programming formulation are defined as follows. In some examples, a_{n,q} represents a fixed cost when carrying bundle q in node n; b_{g,n,q} represents a generalized benefit when all demand in Geo-ID g for bundle q fulfilled via node n; d_{q} represents a number of items in bundle q; eₙ represents an item count (SKU count) capacity at node n; g_{n,s} represents a space available, along dimension s, at node n; h_{n,t} represents a throughput available, along dimension t, at node n; v_{q,s} represents a space required, along dimension s, to store a vendor pack of each item in bundle q; u_{g,n,q,t} represents a throughput required, along dimension t, to satisfy all demand in Geo-ID g for bundle q via node n; w_{g,n,q,s} represents a space required, along dimension s, to store enough on-hand in node n to satisfy all demand in Geo-ID g for bundle q; z^{min}_{n,q,s} represents a minimum space set aside in node n for bundle q along dimension s.

In some embodiments, different decision variables for the placement optimization mathematical programming formulation are defined as follows. In some examples, x_{n,q} represents whether or not bundle q is carried in node n; y_{g,n,q} represents a fraction of demand in Geo-ID g for bundle q served via node n; z_{n,q,s} represents a space set aside, along dimension s, for bundle q in node n.

In some embodiments, an objective function to be maximized the placement optimization mathematical programming formulation is defined as:

Maximize(sum_{g in G}sum_{n in N}sum_{q in Q}b_{g,n,q}y_{g,n,q}−sum_{n in N} sum_{q in Q}a_{n,q}x_{n,q}).

In some embodiments, various constraints for the placement optimization mathematical programming formulation are defined as follows. In some examples, the constraints includes a demand fulfillment or fractional variables constraint defined as: sum_{n in N} y_{g,n,q}=1, for all g in G and q in Q. In some examples, the constraints includes a SKU count constraint defined as: sum_{q in Q} d_{q} x_{n,q}<=eₙ, for all n in N. In some examples, the constraints includes a node volume constraint defined as: sum_{q in Q} z_{n,q,s}<=g_{n,s}, for all n in N and s in S. In some examples, the constraints includes a node throughput constraint defined as: sum_{g in G} sum_{q in Q} v_{g,n,q,t} y_{g,n,q}<=h_{n,t}, for all n in N and tin T. In some examples, the constraints includes consistent x and y variables constraints defined as: x_{n,q}>=y_{g,n,q}, for all g in G, n in N, and q in Q; x_{n,q}<=sum_{g in G} y_{g,n,q}, for all n in N and q in Q. In some examples, the constraints includes consistent x and z variables constraints defined as: z_{n,g,s}<=x_{n,q} w_{g,n,q,s}, for all g in G, n in N, q in Q, and s in S. In some examples, the constraints includes a vendor pack quantity constraint defined as: z_{n,q,s}>=v_{q,s} x_{n,q}, for all q in Q, n in N, and s in S. In some examples, the constraints includes an on-hand requirement constraint defined as: z_{n,q,s}>=sum_{g in G} w_{g,n,q,s} y_{g,n,q}, for all n in N, q in Q, and s in S. In some examples, the constraints includes a super nodes constraint defined as: x_{n,q}=1, for all n in SN and q in Q. In some examples, the constraints includes an item-location eligibility constraint defined as: x_{n,q}=0, for all (n,q) in IL. In some examples, the constraints includes acceptable range constraints defined as: x_{n,q} in {0,1}, for all n in N and q in Q; 0<=y_{g,n,q}<=1, for all g in G, n in N, and q in Q; z^{min}_{n,q,s}<=z_{n,q,s}, for all n in N, q in Q, and s in S.

In some embodiments, the placement optimization engine 645 generates the recommendation data based on: generating model parameters based on the feature data; generating decision variables based on the feature data; generating constraints based on the feature data; and maximizing an objective function while meeting the constraints. In some embodiments, the objective function is computed based on a difference between expected revenue and fulfillment costs. In some embodiments, the objective function is maximized by tuning the decision variables given the model parameters while meeting the constraints.

In some embodiments, the fulfillment costs comprise: product shipment cost, inventory holding cost, and penalty cost for recommendations of removing products from nodes and/or adding products to nodes. In some embodiments, the constraints comprise: a first constraint on space available overall at a node; a second constraint on a volume of space available for storing hazardous materials at a node; a third constraint on a total number of products that can be stored at a node; a fourth constraint on a maximum number of items that can be sent to a node during a time period; a fifth constraint on a maximum number of items that can be sent from a node during a time period; and additional constraints related to operational rules based on requirements from a retailer and/or a vendor. For example, a vendor may not have the capability to ship items across the country or to certain geo locations.

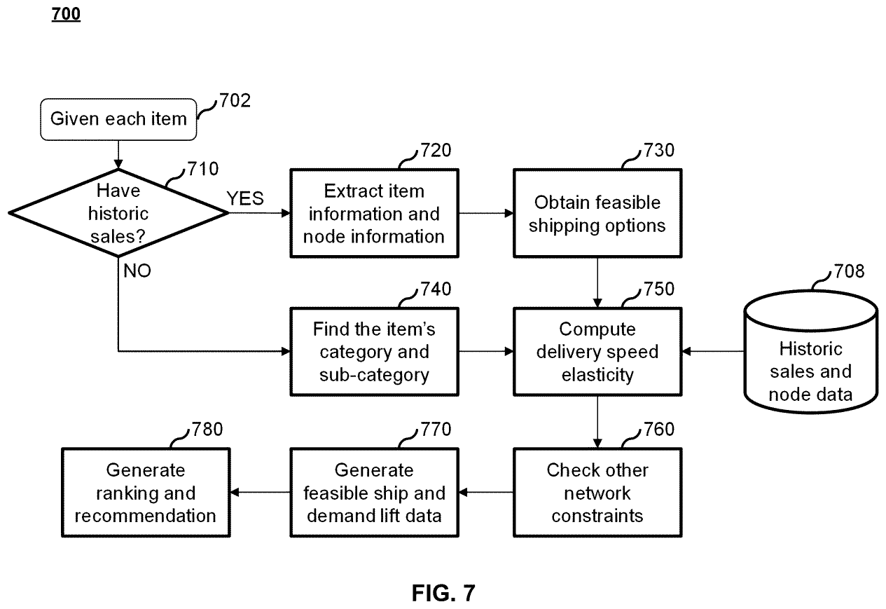

FIG. 7 illustrates an exemplary process 700 for computing and evaluating delivery speed elasticity, in accordance with some embodiments of the present teaching. In some embodiments, the process 700 can be carried out by one or more computing devices, such as the inventory placement and demand allocation device 102 and/or the cloud-based engine 121 of FIG. 1. In some embodiments, the process 700 can be performed by the delivery speed elasticity module 641 and/or the demand update module 644 in FIG. 6.

As shown in FIG. 7, the process 700 starts from operation 710, where for each given item 702, it is determined whether the item 702 has historic sales data. If so, the process 700 goes to operation 720, to extract data including item information and node information from the sales history for the item 702. Then the process 700 goes to operation 730 to obtain feasible shipping options, e.g. from the sales history for the item 702. The process 700 then goes to operation 750 to compute a delivery speed elasticity for the item 702 based on the extracted data.

Otherwise, if it is determined at the operation 710 that the item 702 lacks historic sales data or is a new item, the process 700 goes to operation 740 to determine a categorical hierarchy for the item 702, including the item's category and sub-category. The process 700 then goes to the operation 750 to compute a delivery speed elasticity for the item 702 based on the categorical hierarchy.

In either case happened at the operation 710, the delivery speed elasticity is computed for the item 702 at the operation 750, based on historic sales and node data 708. At operation 760, one or more constraints of the retail fulfillment network are obtained and checked. For the item 702 and for each of a set of feasible shipping speed options, a demand update is generated at operation 770, based on the delivery speed elasticity, while meeting the one or more constraints. Based on the predicted demand update, a ranked list of recommended shipping speed options is generated at operation 780 for the item 702. In some embodiments, based on the ranked list for each item, the system can compute recommendations regarding inventory placement and demand allocation among the nodes in the retail fulfillment network.

As such, FIG. 7 shows a delivery speed elasticity framework to quantify the impact of faster shipping on more customer demand. In some embodiments, when an item is received, it is verified if the item is present in the sales history. If present, the system retrieves the item and node information, alongside the identification of potential shipping options. The information is then utilized to calculate the delivery speed elasticity. For items that lack historical data or are entirely new, the system utilizes the item's categorical hierarchy, referring to similar items to estimate elasticity. The system then assesses the network's constraints and feasible shipping options and predicts demand lift (or fall). This ensures that the recommended shipping options are not only attractive to customers, but also logistically feasible and profitable. The system provides a comprehensive ranking and recommendation at the item level for the ideal shipping speed, based on feasible shipping and demand lift prediction.

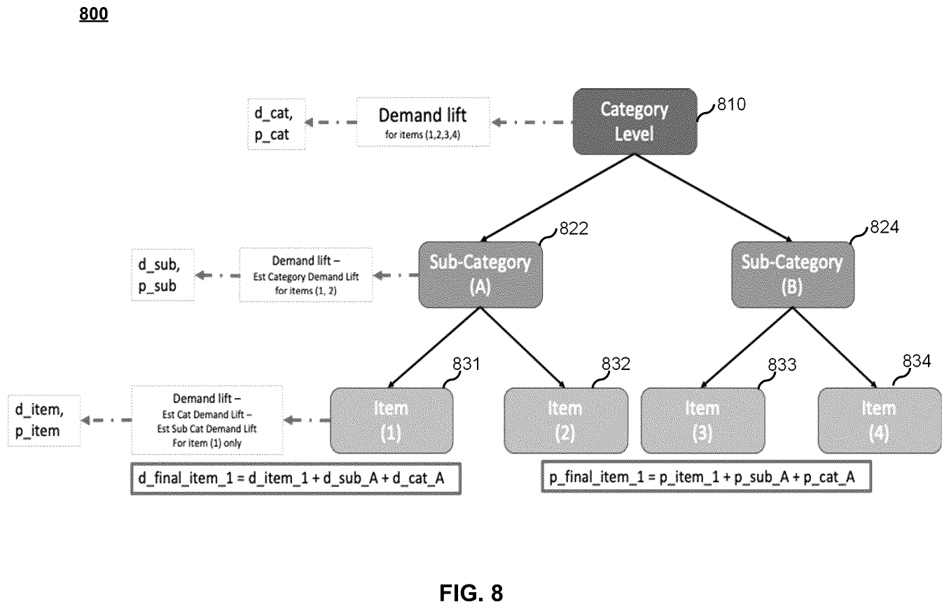

FIG. 8 illustrates an exemplary item category hierarchy 800, in accordance with some embodiments of the present teaching. As shown in FIG. 8, the item category hierarchy 800 includes different hierarchical levels for items. For example, a category 810 includes two sub-categories: sub-category A 822 and sub-category B 824. The sub-category A 822 includes items 831, 832. The sub-category B 824 includes items 833, 834. A demand lift can be computed at the item level, at the sub-category level, and/or at the category level. For example, if item 833 is a new item lacking sales history, a demand lift may be computed for the item 833 at the level of sub-category B 824. In some embodiments, a machine learning model is trained at category level for computing delivery speed elasticity for all of the items on the same category. The trained machine learning model may then be used to compute delivery speed elasticity at both the category level and the sub-category level, or even the item level.

In some embodiments, the delivery speed elasticity is computed based on a multi-level elasticity model. The model can be extended to any regression problem, where the data has hierarchical structure, and can address the lack of enough data challenge. In some embodiments, a specific weekly sale is considered base sale, if both delivery speed during the week and the unit price fall within a percentage of base speed and base price. For example, a delivery speed is within 6 hours of base speed; and the weekly unit price is within 5 percent of the base price. The remaining weeks are called non-base weekly sales, which include some variations in price and/or delivery speed.

In some embodiments, the elasticity parameter at each level can be modelled using standard linear regression. The demand lift can be computed as:

log(Demand Lift)=delivery_speed_elasticity*(delivery_speed−base_delivery_speed)+price_elasticity*(price−base_price)+error.

In some embodiments, for any new item or item lacking sales history, a multi-level regression extension model recognizes the existence of data hierarchies to address the lack of adequate historic data issue for improving the modelling performance. In some examples, the system can denote the weekly sales by S, base sales or average weekly sales by S_{b}, delivery speed by D, price by P, elasticity by el, and items by i∈I. The system can first compute:

$$Demand Lift = \frac{S}{{S}_{b}} \qquad [ 1 ]$$

$$log ( Demand {lift}_{i} ) = {el}_{{D}_{i}} ( {D}_{i} - {D}_{{b}_{i}} ) + {el}_{{P}_{i}} ( {P}_{i} - {P}_{{b}_{i}} ) + ε \qquad [ 2 ]$$

Here, only the delivery speed part is shown in equation [2] to simply the notation. However, equation [2] can be extended include the price part as well. Then, the system can compute:

$$log ( Demand {lift}_{i} ) = {el}_{{D}_{i}} ( {D}_{i} - {D}_{{b}_{i}} ) \qquad [ 3 ]$$

From equation [1], the system can compute:

$$\begin{matrix}log ( Demand {lift}_{i} ) = log ( \frac{{S}_{i}}{{s}_{{b}_{i}}} ) = log ( \frac{{s}_{i}}{{s}_{a d {j}_{{b}_{i}}}} \times \frac{{s}_{a d {j}_{{b}_{i}}}}{{s}_{{b}_{i}}} ) \\ = log ( \frac{{s}_{i}}{{s}_{a d {j}_{{b}_{i}}}} ) + log ( \frac{{s}_{a d {j}_{{b}_{i}}}}{{s}_{{b}_{i}}} )\end{matrix} \qquad [ 4 ]$$

From equations [3] and [4], the system can compute:

$$log ( \frac{{s}_{i}}{{S}_{a d {j}_{{b}_{i}}}} ) = {el}_{{D}_{s u {b}_{i}}} ( {D}_{i} - {D}_{{b}_{i}} ) \qquad [ 5 ]$$

where i∈items of subcategory,

$${S}_{{adj}_{{b}_{i}}}$$

is the estimation of base sales in the subcategory, and equation [5] is the estimation of the demand lift in the subcategory level. Therefore, the second term in equation [4] is the estimation of demand lift in the item level.

In some embodiments, equation [4] can be extended to different category levels of items, as shown in FIG. 8. In some embodiments, using only equation [3] at item level with small amount of historical data may not achieve accurate and reliable results. Equations [4] and [5] can help to borrow information from the higher categories to the item level regarding their elasticity in their speed, especially in the case of inadequate data at item level. In some embodiments, the delivery speed elasticity is computed for each item for each Geo-ID, as customers from different geo locations may react differently to a delivery speed for a given item.

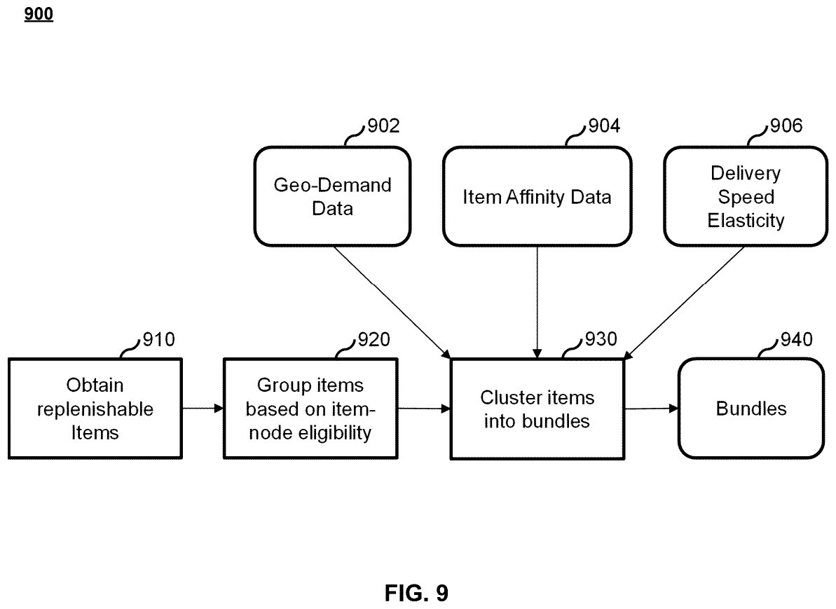

FIG. 9 illustrates a process 900 for generating item bundles, in accordance with some embodiments of the present teaching. In some embodiments, the process 900 can be carried out by one or more computing devices, such as the inventory placement and demand allocation device 102 and/or the cloud-based engine 121 of FIG. 1. In some embodiments, the process 900 can be performed by the item bundling module 642 in FIG. 6.

As shown in FIG. 9, the process 900 starts from operation 910, where replenishable items are obtained. In some embodiments, the process 900 can be extended to other types of items as well. At operation 920, the items are grouped based on item-node eligibility. Then at operation 930, the items are clustered into a plurality of bundles 940 based on geo-demand data 902, item affinity data 904 and delivery speed elasticity data 906.

In some embodiments, the geo-demand data 902 includes a geo-demand representation for each item. The geo-demand representation represents a down-stream demand of the item at each given geographic location. In some embodiments, the geo-demand representation is predicted based on a machine learning model, which is trained based on historical item demand data at different geographic locations.

In some embodiments, the item affinity data 904 includes an item affinity score computed for each item pair of two items. The item affinity score measures how much more likely the two items are to be purchased together than if they were purchased independently.

In some embodiments, the delivery speed elasticity data 906 includes a delivery speed elasticity computed for each item at each given geographic location. The delivery speed elasticity may be computed based on the method disclosed above referring to FIG. 7 and FIG. 8.

In some embodiments, for each of the plurality of bundles 940, the system provides a same recommendation regarding inventory placement and demand allocation for all items in the bundle. This can help reducing packages being shipped, as customers like to have one package shipped to them per each order. In some embodiments, a total number of items in each bundle has an upper bound that depends on a total sales volume of the bundle. In some examples, the upper bound increases as the total sales volume decreases. For example, the upper bound may be 10 items in one bundle for top selling items; but may be >1000 items in one bundle for low selling items.

In some embodiments, the disclosed system integrates delivery speed elasticity and affinity into the placement optimization engine by clustering items into bundles. The delivery speed elasticity of each item is also considered in placing the item closest/farthest on the retail fulfillment network from the demand, thus easing out the SKU constraint at busy fulfilment centers. In addition, an affinity can be measured as pair lift, i.e., how much more likely two items are to be purchased together than if they were purchased independently, which reduces the split cost significantly if jointly considered in placement.

In some embodiments, the system can identify bundles, with feature representation for each item includes the following components: (1) a geo-demand vectorization that represents the down-stream demand to account for bundling identical items in a bundle; (2) an affinity recommendation to place similar items together in a bundle; and (3) a delivery speed elasticity component represented at an item and Geo-ID combination level. The geo-demand vectorization may be the output of a machine learning model, which predicts the demand of an item at a particular geo location. The affinity captures the measure of how much more likely two items are to be purchased together than if they were purchased independently. In some embodiments, other item related attributes, e.g. dimensions of the product, will be included in the representation as well.

In some embodiments, a pairwise lift value is used to measure affinity, based on historic co-occurrence. By incentivizing items from the same cluster to be co-located, the system can effectively reduce the chance of an order split and thus lead to savings in fulfillment cost. To integrate the feedback into the bundling step, prior to calling the placement optimization engine, the feedback bundles can be embedded as one-hot encoding into the feature representation from each item.

In some embodiments, during the bundling, system uses a method based on constrained k-means that controls the number of items in each bundle. In the constrained k-means, explicit constraints are added to the underlying clustering optimization problem requiring that each cluster has at least a minimum (and a maximum) number of items in the bundle. Since clusters with very few or no data points may be artifacts of poor local minima, and the downstream optimization engine takes placement decisions on the bundle, controlling the number of items lead to superior performance in the downstream engine.

In some embodiments, to scale the clustering algorithm at an item level, the system uses hierarchical clustering, which is a divisive approach where all observations start in one cluster, and splits are performed recursively as one move down the hierarchy. Clustering algorithm scales linearly with the number of clusters and the hierarchical clustering approach can often be much faster than regular K-means. In some embodiments, the system combines hierarchical clustering with constrained k-means to help with the scalability issue.

In some embodiments, upon identifying the bundles, the downstream placement optimization engine optimizes for a joint decision variable for each item in the bundle. The benefit of placing a bundle at each node on the network is computed as the cumulative measure of benefit of placing every item in the bundle at the considered node. This reduces the number of decision variables, and also allows the system to approximate the problem by reformulating it in terms of the aggregate items. A disaggregation approach may be used to handle each bundle independently to determine the decision variables at an item level.

In some embodiments, the system can provide updated recommendations for inventory placement and demand allocation, every day, every week, every month, or at a predetermined frequency, or upon request.

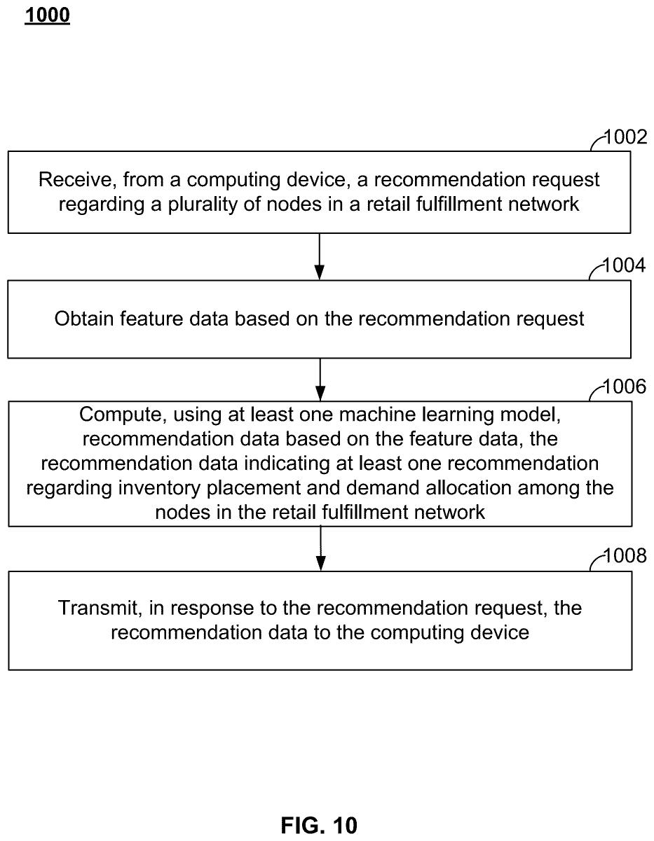

FIG. 10 is a flowchart illustrating an exemplary method 1000 for recommending inventory placement and demand allocation of items, in accordance with some embodiments of the present teaching. In some embodiments, the method 1000 can be carried out by one or more computing devices, such as the inventory placement and demand allocation device 102 and/or the cloud-based engine 121 of FIG. 1. Beginning at operation 1002, a recommendation request regarding a plurality of nodes in a retail fulfillment network is received from a computing device. At operation 1004, feature data is obtained based on the recommendation request. At operation 1006, recommendation data is computed using at least one machine learning model based on the feature data. The recommendation data indicates at least one recommendation regarding inventory placement and demand allocation among the nodes in the retail fulfillment network. At operation 1008, the recommendation data is transmitted to the computing device in response to the recommendation request.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, a recommendation request regarding a plurality of nodes in a retail fulfillment network,
obtain feature data based on the recommendation request,
compute, using at least one machine learning model, recommendation data based on the feature data, wherein the recommendation data indicates at least one recommendation regarding inventory placement and demand allocation among the nodes in the retail fulfillment network, and
transmit, in response to the recommendation request, the recommendation data to the computing device.

2. The system of claim 1, wherein each node in the retail fulfillment network comprises at least one of:
a store, a warehouse, a fulfillment center, or a distribution center.

3. The system of claim 1, wherein the feature data comprises data related to at least one of:
at least one fixed rule each specifying a certain product must be placed in one or more certain nodes;
an item-location eligibility indicating which products are eligible for placement in which nodes;
an item affinity, which includes pair-wise scores each indicating how likely a pair of two products will be purchased together;
customer experience scores, which includes data on uplift in customer satisfaction when certain products are available to be delivered in a certain timeframe;
a current inventory indicating quantities of each product currently stored in each node;
item prices indicating prices of items and a revenue a retailer receives when selling each product;
picking costs indicating costs of taking each product out of inventory at each node;
shipment costs indicating costs of shipping one unit of any product from any node to any given customer location;
a geo-demand indicating a baseline demand for each product, which is broken down by geographic area;
a promise definition indicating a speed with which the retailer is capable of delivering a product from a given node to a customer in a geographic area;
target days of supply indicating an amount of product which must be carried in a node in order to support retailer deliveries from the node to avoid out of stock;
node attributes indicating attributes on each node;
a delivery speed elasticity; or
clusters of items that need to be placed together to maximize revenue and minimize cost.

4. The system of claim 1, wherein the recommendation data comprises data related to at least one of:
demand allocation ratios indicating what fraction of demand for each product in each geographic area each week will be served via each node;
binary placement decisions indicating whether each product will or will not be stored in each node each week;
reason codes each including descriptions of one or more reasons behind a corresponding binary placement decision;
automated validation data including a list of validation checks performed during recommendation output generation and information on whether the validation checks were successful; or
sale related benefit data indicating individual costs and benefits considered during recommendation output generation.

5. The system of claim 1, wherein the recommendation data is computed based on:
generating model parameters based on the feature data;
generating decision variables based on the feature data;
generating constraints based on the feature data; and
maximizing an objective function while meeting the constraints, wherein:
the objective function is computed based on a difference between expected revenue and fulfillment costs, and
the objective function is maximized by tuning the decision variables given the model parameters while meeting the constraints.

6. The system of claim 5, wherein the fulfillment costs comprise:
product shipment cost, inventory holding cost, and penalty cost for recommendations of removing products from nodes and/or adding products to nodes.

7. The system of claim 5, wherein the constraints comprise:
a first constraint on space available overall at a node;
a second constraint on a volume of space available for storing hazardous materials at a node;
a third constraint on a total number of products that can be stored at a node;
a fourth constraint on a maximum number of items that can be sent to a node during a time period;
a fifth constraint on a maximum number of items that can be sent from a node during a time period; and
additional constraints related to operational rules based on requirements from a retailer and/or a vendor.

8. The system of claim 1, wherein the recommendation data is computed based on:
determining, for each item, whether the item has a sales history;
for items with a sales history:
extracting, for each item, data including item information, node information and shipping options from the sales history, and
computing a delivery speed elasticity for each item based on the extracted data;
for items lacking a sales history:
determining, for each item, a categorical hierarchy, and
computing a delivery speed elasticity for each item based on the categorical hierarchy;
predicting, for each item and for each of a set of feasible shipping speed options, a demand update based on the delivery speed elasticity, given at least one constraint of the retail fulfillment network;
generating, for each item, a ranked list of recommended shipping speed options based on the predicted demand update; and
computing, based on the ranked list for each item, the at least one recommendation regarding inventory placement and demand allocation among the nodes in the retail fulfillment network.

9. The system of claim 1, wherein the recommendation data is computed based on:
determining, for each item, a geo-demand representation representing a down-stream demand of the item at each given geographic location;
determining, for each item pair of two items, an item affinity measuring how much more likely the two items are to be purchased together than if they were purchased independently;
determining, for each item, a delivery speed elasticity at each given geographic location;
clustering items of the retail fulfillment network into a plurality of bundles based on the geo-demand representation, the item affinity and the delivery speed elasticity; and
computing, for each of the plurality of bundles, a same recommendation regarding inventory placement and demand allocation for all items in the bundle.

10. The system of claim 9, wherein:
the geo-demand representation is predicted based on a machine learning model, which is trained based on historical item demand data at different geographic locations;
a total number of items in each bundle has an upper bound that depends on a total sales volume of the bundle; and
the upper bound increases as the total sales volume decreases.

11. A computer-implemented method, comprising:
receiving, from a computing device, a recommendation request regarding a plurality of nodes in a retail fulfillment network;
obtaining feature data based on the recommendation request;
computing, using at least one machine learning model, recommendation data based on the feature data, wherein the recommendation data indicates at least one recommendation regarding inventory placement and demand allocation among the nodes in the retail fulfillment network; and
transmitting, in response to the recommendation request, the recommendation data to the computing device.

12. The computer-implemented method of claim 11, wherein each node in the retail fulfillment network corresponds to at least one of:
a store, a warehouse, a fulfillment center, or a distribution center.

13. The computer-implemented method of claim 11, wherein the feature data comprises data related to at least one of:
at least one fixed rule each specifying a certain product must be placed in one or more certain nodes;
an item-location eligibility indicating which products are eligible for placement in which nodes;
an item affinity, which includes pair-wise scores each indicating how likely a pair of two products will be purchased together;
customer experience scores, which includes data on uplift in customer satisfaction when certain products are available to be delivered in a certain timeframe;
a current inventory indicating quantities of each product currently stored in each node;
item prices indicating prices of items and a revenue a retailer receives when selling each product;
picking costs indicating costs of taking each product out of inventory at each node;
shipment costs indicating costs of shipping one unit of any product from any node to any given customer location;
a geo-demand indicating a baseline demand for each product, which is broken down by geographic area;
a promise definition indicating a speed with which the retailer is capable of delivering a product from a given node to a customer in a geographic area;
target days of supply indicating an amount of product which must be carried in a node in order to support retailer deliveries from the node to avoid out of stock;
node attributes indicating attributes on each node;
a delivery speed elasticity; or
clusters of items that need to be placed together to maximize revenue and minimize cost.

14. The computer-implemented method of claim 11, wherein the recommendation data comprises data related to at least one of:
demand allocation ratios indicating what fraction of demand for each product in each geographic area each week will be served via each node;
binary placement decisions indicating whether each product will or will not be stored in each node each week;
reason codes each including descriptions of one or more reasons behind a corresponding binary placement decision;
automated validation data including a list of validation checks performed during recommendation output generation and information on whether the validation checks were successful; or
sale related benefit data indicating individual costs and benefits considered during recommendation output generation.

15. The computer-implemented method of claim 11, wherein computing the recommendation data comprises:
generating model parameters based on the feature data;
generating decision variables based on the feature data;
generating constraints based on the feature data; and
maximizing an objective function while meeting the constraints, wherein:
the objective function is computed based on a difference between expected revenue and fulfillment costs, and
the objective function is maximized by tuning the decision variables given the model parameters while meeting the constraints.

16. The computer-implemented method of claim 15, wherein:
the fulfillment costs comprise: product shipment cost, inventory holding cost, and penalty cost for recommendations of removing products from nodes and/or adding products to nodes; and
the constraints comprise:
a first constraint on space available overall at a node,
a second constraint on a volume of space available for storing hazardous materials at a node,
a third constraint on a total number of products that can be stored at a node,
a fourth constraint on a maximum number of items that can be sent to a node during a time period,
a fifth constraint on a maximum number of items that can be sent from a node during a time period, and
additional constraints related to operational rules based on requirements from a retailer and/or a vendor.

17. The computer-implemented method of claim 11, wherein computing the recommendation data comprises:
determining, for each item, whether the item has a sales history;
for items with a sales history:
extracting, for each item, data including item information, node information and shipping options from the sales history, and
computing a delivery speed elasticity for each item based on the extracted data;
for items lacking a sales history:
determining, for each item, a categorical hierarchy, and
computing a delivery speed elasticity for each item based on the categorical hierarchy;
predicting, for each item and for each of a set of feasible shipping speed options, a demand update based on the delivery speed elasticity, given at least one constraint of the retail fulfillment network;
generating, for each item, a ranked list of recommended shipping speed options based on the predicted demand update; and
computing, based on the ranked list for each item, the at least one recommendation regarding inventory placement and demand allocation among the nodes in the retail fulfillment network.

18. The computer-implemented method of claim 11, wherein computing the recommendation data comprises:
determining, for each item, a geo-demand representation representing a down-stream demand of the item at each given geographic location;
determining, for each item pair of two items, an item affinity measuring how much more likely the two items are to be purchased together than if they were purchased independently;
determining, for each item, a delivery speed elasticity at each given geographic location;
clustering items of the retail fulfillment network into a plurality of bundles based on the geo-demand representation, the item affinity and the delivery speed elasticity; and
computing, for each of the plurality of bundles, a same recommendation regarding inventory placement and demand allocation for all items in the bundle.

19. The computer-implemented method of claim 18, wherein:
the geo-demand representation is predicted based on a machine learning model, which is trained based on historical item demand data at different geographic locations;
a total number of items in each bundle has an upper bound that depends on a total sales volume of the bundle; and
the upper bound increases as the total sales volume decreases.

20. A non-transitory computer readable medium having instructions stored thereon, wherein the instructions, when executed by at least one processor, cause at least one device to perform operations comprising:
receiving, from a computing device, a recommendation request regarding a plurality of nodes in a retail fulfillment network;
obtaining feature data based on the recommendation request;
computing, using at least one machine learning model, recommendation data based on the feature data, wherein the recommendation data indicates at least one recommendation regarding inventory placement and demand allocation among the nodes in the retail fulfillment network; and
transmitting, in response to the recommendation request, the recommendation data to the computing device.
